(19) United States
(12) Patent Application Publication
(10) Pub. No.: US 2008/0270685 A1
(43) Pub. Date: Oct. 30, 2008

(54) INFORMATION PROCESSING APPARATUS AND FIRMWARE UPDATING METHOD

(75) Inventor: Yuuichiro Kato, Hamura-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/062,679

(22) Filed: Apr. 4, 2008

(30) Foreign Application Priority Data
Apr. 27, 2007 (JP) 2007-119930

(51) Int. Cl. G06F 12/00

(52) U.S. Cl. 711/112; 711/159; 711/E12.001

(57) ABSTRACT

According to one embodiment, an information processing apparatus, includes a controller configured to execute processing based on firmware stored in a nonvolatile memory, a storage device configured to store updating data to update the firmware and update application code, and a processor configured to execute processing to pose a state of no-fragmentation of the update application code and the updating data, processing to acquire address information showing storage places of the update application code and the updating data, processing to write updating information including address information of the update application code and the updating data, processing to load the update application code in the storage device in a memory on the basis of the updating information, and processing to update the firmware by using the updating data on the basis of the update application code loaded in the memory before booting an operating system having a multitasking function.

### CROSS-REFERENCE TO RELATED APPLICATIONS

This application is based upon and claims the benefit of priority from Japanese Patent Application No. 2007-119930, filed April, 27, 2007, the entire contents of which are incorporated herein by reference.

### BACKGROUND

1. Field

One embodiment of the present invention relates to an information processing apparatus such as a personal computer. More specifically, the invention relates to an information processing apparatus configured to have a function of updating firmware stored in a nonvolatile memory and to a firmware updating method.

2. Description of the Related Art

A disk storage device includes a disk medium on which data is recorded by a head. Usually, the disk storage device is used by being connected to a host system using the disk storage device. The host system is generally a personal computer which uses the disk storage device as an auxiliary storage device (large capacity storage device). The disk storage device executes a variety of kinds of processing including data recording onto a disk medium and reading the data therefrom. These kinds of processing are actualized in a way in which a controller in the disk storage device executes a program (control program) stored in a nonvolatile memory provided for the disk storage device.

A recent disk storage device is required to rewrite the program stored in a nonvolatile memory in the disk storage device into an updated one.

To rewrite in safety the program stored in the nonvolatile memory in the disk storage device, it becomes necessary that the disk storage device is not accessed from the host system other than the rewriting of the program during the rewriting of the program. However, if the host system is a personal computer, an operation system (OS) of the computer generally has a multitasking function which can executes a plurality of tasks (programs) in parallel. Like this, under an environment in which the plurality of tasks are executed in parallel, it is dangerous to rewrite the program stored in the nonvolatile memory in the disk storage device.

Therefore, conventionally, to restart the whole of the host system after the rewriting of the program, and to prevent an occurrence of access from the host system to the disk storage device in a period for the rewriting the program in the nonvolatile memory, the following method has been employed. At first, the method prepares a flexible disk with a boot program having a minimum of a boot function and an application program for program rewriting which adopting to an architecture (computer architecture) of the host system stored thereon. The method mounts the flexible disk on a flexible disk drive to run the program on the flexible disk then rewriting the program in the aforementioned procedure.

However, recently, since information processing apparatuses with no flexible disk mounted thereon have increased in number, the cases, in which it is hard to execute commands for rewriting the firmware without starting operating systems, have been on the increase.

A technique for rewriting the firmware without using the flexible disk is disclosed in Jpn. Pat. Appln. KOKAI Publication No. 2002-244874. The method disclosed in this patent document is briefly described below. A firmware update application requests “power-off and firmware update” to an operating system. The operating system receives this request to shut down itself, and when shut-down processing is completed, the operating system transmits an event of the “power-off and firmware update” to a basic input output system (BIOS), and the BIOS responds to the event and updates the firmware by executing a firmware update program in the memory.

Meanwhile, if the host system is a personal computer, the method can update the firmware in many cases. However, in the case of an information processing apparatus which uses an operating system for a built-in device used for a point of sales system (POS) register, etc., since the shut-down processing for the operating system is different from that of the usual operating system, the foregoing method is not usable. Therefore, a method updating the firmware at the time of power-on has been desired.

Since the firmware is updated in a state in which the power is not perfectly turned off, there is some possibility that the firmware cannot be normally updated.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a preferred block diagram illustrating a system configuration of an information processing apparatus regarding an embodiment of the present invention;

FIG. 2 is a preferred block diagram illustrating a configuration for updating firmware of a device in the information processing apparatus illustrated in FIG. 1;

FIG. 3 is a preferred view illustrating an arrangement configuration of data in a hard disk drive regarding the embodiment of the invention;

FIG. 4 is a preferred view illustrating an arrangement configuration of data in a memory regarding the embodiment of the invention; and

FIG. 5 is a preferred flowchart illustrating a procedure for updating the firmware of the device in the information processing apparatus illustrated in FIG. 1.

### DETAILED DESCRIPTION

Various embodiments according to the invention will be described hereinafter with reference to the accompanying drawings. In general, according to one embodiment of the invention, an information processing apparatus, comprises a memory, a device including a nonvolatile memory with firmware stored therein and a controller configured to execute processing based on the firmware, a storage device configured to store updating data to update the firmware stored in the nonvolatile memory and update application code, and a processor configured to execute processing to pose a state of no-fragmentation of the update application code and the updating data, processing to acquire address information showing storage places of the update application code and the updating data, processing to write updating information including address information of the update application code and the updating data, processing to detect whether or not the updating information is written in the storage device at the time of power-on, processing to load the update application code in the storage device in the memory on the basis of the updating information when it is determined that the updating information is written, and processing to update the firmware stored in the nonvolatile memory by using the updating data on the basis of the update application code loaded in the memory before booting an operating system having a multitasking function.

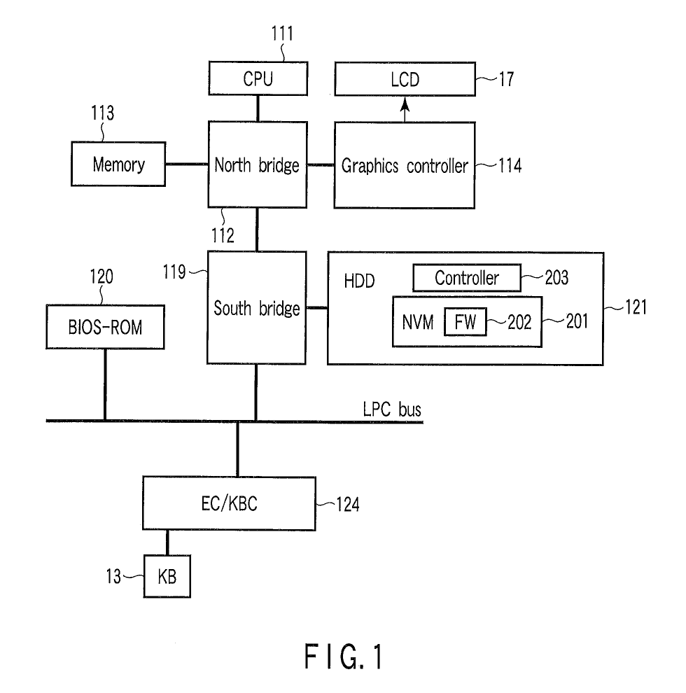

At first, a configuration of an information processing apparatus regarding an embodiment of the invention will be described by referring to FIG. 1. This apparatus is actualized as a portable notebook-type personal computer 10 capable of being driven by a rechargeable battery. FIG. 1 is a block diagram illustrating an example of a system configuration of the personal computer 10.

The computer 10 includes, as shown in FIG. 1, a central processing unit (CPU) 111, a north bridge 112, a main memory 113, a graphics controller 114, a south bridge 112, a main memory 113, a graphics controller 114, a south bridge 119, a BIOS-ROM 120, a hard disk drive (HDD) 121 and an embedded controller/keyboard controller IC (EC/KBC) 124.

The CPU 111 is a processor provided for controlling operations of the computer 10, and executes an operating system having a multitasking function and a variety of application programs which are loaded from the HDD 121 to the main memory 113. The operating system has a window system to display a plurality of windows on a display screen.

The CPU 111 also executes a system BIOS (Basic Input Output System) stored in the BIOS-ROM 120. The system BIOS is a program for hardware control.

The north bridge 112 has a memory controller to perform access control of the main memory 113 built-in. The north bridge 112 also has a function of performing a communication with the graphics controller 114 via a PCI EXPRESS bus, etc.

The graphics controller 114 is a display controller which controls an LCD 17 to be used as a display monitor of the computer 10. This graphics controller 114 has a video memory (VRAM), and generates a video signal which forms a display image to display on the LCD 17 from display data drawn on the VRAM by means of the operating system and application programs.

The south bridge 119 controls each device on a low pin count (LPC) bus. The south bridge 119 has an integrated drive electronics (IDE) controller to control the HDD 121 built-in. Further, the south bridge 119 has a function to apply access control to the BIOS-ROM 120.

The HDD 121 performs various kinds of processing including data recording onto a disk medium and data reading therefrom. These kinds of processing are realized by the results of execution of firmware (control program) 202, which is stored in a nonvolatile memory (NVM) 201 disposed in the HDD 121, by the controller 203.

An embedded controller/keyboard controller IC (EC/KBC) 124 is a one-chip microcomputer with an embedded controller for power supply control and heat radiation control and a keyboard (KB) controller for controlling a keyboard 13 integrated therein.

Meanwhile, the firmware 202 in the HDD 121 is rewritten sometimes so as to correct its failure, to add a new function, etc. Hereinafter, a configuration to update the firmware 202 in the HDD 121 will be described.

In this embodiment, the information processing apparatus sets to update the firmware 202 in starting an operating system having the multitasking function, and updates the firmware 202 before starting the operating system after restarting.

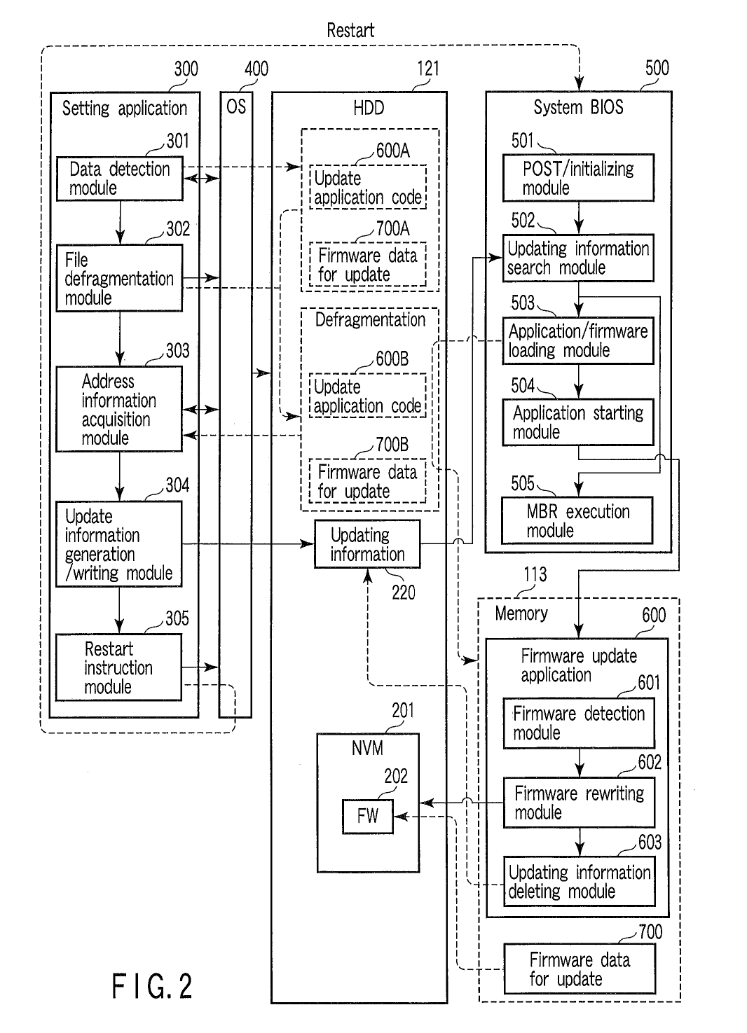

FIG. 2 is a block diagram showing a system configuration to update the firmware 202 in the HDD 121.

As shown in FIG. 2, update of the firmware 202 is implemented through a setting application 300, an operating system 400, a system BIOS 500, a firmware update application (hereinafter referred to an update application) 600, etc. The setting application 300 and the update application 600 are programs executed by the CPU 111.

The setting application 300 includes a data detection module 301, a file defragmentation module 302, an address information acquisition module 303, an updating information generation/writing module 304, and a restart instruction module 305. The data detection module 301, the file defragmentation module 302, address information acquisition module 303, the updating information generation/writing module 304, and the restart instruction module 305 are programs executed by the CPU 111.

The data detection module 301 detects the paths of firmware update application code 600A and firmware data for update 700A. The data detection module 301 displays a file dialog box in order to detect the path of the firmware update application code 600A, and makes a user specify the firmware update application code 600A. The data detection module 301 displays a file dialog box in order to detect the path for the firmware data for update 700A and makes the user specify the firmware data for update 700A.

The firmware update application code 600A and the firmware data for update 700A may be prepared by downloading from a web server, etc., by the user in advance, and the setting application 300 may have a function to automatically download the update application code 600A and the firmware data for update 700A from the web server. The application code 600A may be automatically executed, may access the web server to confirm the presence or absence of the firmware, and if the firmware is present, the firmware may be automatically downloaded to automatically update the firmware.

The file defragmentation module 302 executes a command for the operating system 400 having a multitasking function so as to maintain the continuity of the data in areas continued to each of the firmware update application code 600A and the firmware data for update 700A. The operating system 400 applies defragmentation to each of the firmware update application code 600A and the firmware data for update 700A. The files after the defragmentation are the firmware update application code 600B and firmware data for update 700B.

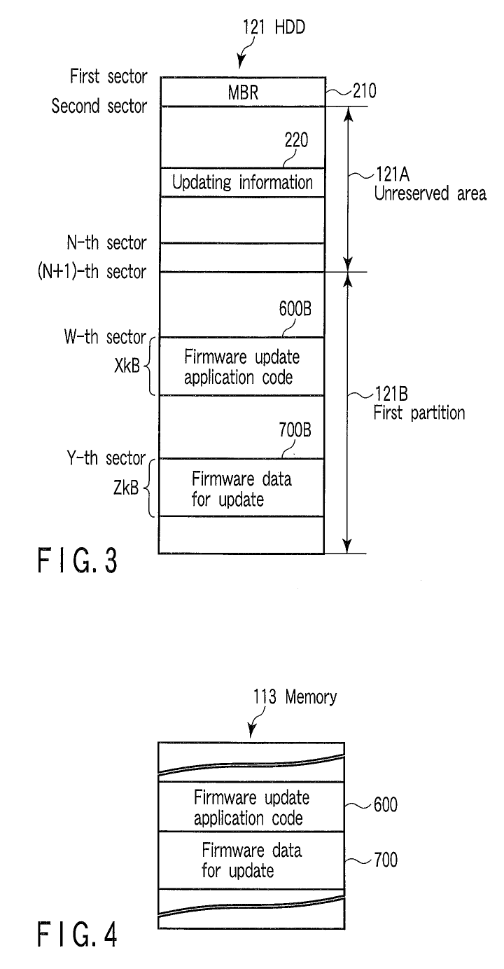

By applying the defragmentation to the update application code 600B, it is stored, as shown in FIG. 3, in continuous areas of X Kbytes from the W-th sector in a state of maintaining the continuity of the data. The firmware data for update 700B is stored, as sown in FIG. 3, in continuous areas of Z Kbytes from the Y-th sector in a state of maintaining the continuity of the data.

In FIG. 3, a bootstrap loader, a partition table, and a boot signature are stored in a master boot record (MBR) 210 of the first sector (head sector, boot sector).

A first partition 121B is started from an (N+1)-th sector. The data of the operating system 400 having a multitasking function, a user application, user data, etc., are stored in the first partition 121B.

An area between the first sector and the first partition, namely an area 121A from the second sector up to the N-th sector is unreserved area which is not used usually. The size of the area 121A is 63 sectors in the case of Windows XP.

The address information acquisition module 303 transfers the paths for the firmware update application code 600B and the firmware data for update 700B to the operating system 400, issues a command so as to acquire address information showing each storage place in the HDD 121, and acquires the address information from the operating system 400. The address information shows a logical block address (LBA) of a head sector of the storage area and a size (usually, integer multiple of 512 bytes) of the storage area. In this example, the address information is address information of an LBA system.

The updating information generation/writing module 304 generates updating information 220 in which prescribed indexes are added to the address information on the firmware update application 600 and the firmware data to store the updating information 220 in a specified area in the HDD 121. The updating information 220 is, as shown in FIG. 3, stored in the unreserved area 121A. The unreserved area 121A is an area not used usually; however since some applications use the area 121A, the generation/writing module 304 writes the updating information 220 in a free space.

After writing the updating information 220 in the area 121A, the defragmentation module 302 issues a restart command to the operating system 400.

Next, the following will describe the system BIOS 500. The system BIOS 500 includes a power-on self test (POST)/initializing module 501, an updating information search module 502, an application/firmware loading module 503, an application starting module 504, and an MBR execution module 505. The POST/initializing module 501, the updating information search module 502, the application/firmware loading module 503, the application starting module 504, and the MBR execution module 505 are programs to be executed by the CPU 111.

The POST/initializing module 501 executes a POST to check whether necessary devices normally operate or not. Simultaneously, the POST/initializing module 501 also initializes these peripheral devices.

The search module 502 detects the updating information 220 from the unreserved area 121A on the basis of a prescribed index owned by the updating information 220.

The application/firmware loading module 503 reads the firmware update application code 600B and the firmware data for update 700B from the HDD 121, based on the updating information 220 detected by the search module 502, and loads them in the memory 112 sequentially. As depicted in FIG. 4, on the memory 113, the firmware data 700 is stored in an area starting from the subsequent address of the firmware update application 600.

The application starting module 504 starts the firmware update application 600 loaded in the memory 113. The booting unit searches the MBR 210 to execute it.

The firmware update application 600 includes a firmware detection module 601, a firmware rewriting module 602, and an updating information deleting module 603. The firmware detection module 601, the firmware rewriting module 602, and the updating information deleting module 603 are programs to be executed by the CPU 111.

The firmware detection module 601 detects an area, on the memory 113, in which the firmware data for update 700 is stored. The firmware detection module 601 reads the updating information 220 to recognize the size of the firmware data 700. The firmware data on the memory 113 is stored in an area starting from the subsequent address of the firmware update application 600 on the memory 113. Therefore, the firmware detection module 601 detects the firmware data on the memory 113 from the address in the portion after the position of the firmware update application 600 and the size of the firmware data 700.

The firmware rewriting module 602 uses the firmware data 700 on the memory 113 detected by the firmware detection module 601 to update the firmware data 202 in the nonvolatile memory 201.

The deleting module 603 deletes the updating information 220 from the HDD 121 after terminating the update of the firmware, and after deleting, the deleting module 603 transmits a restart command to the system BIOS 500.

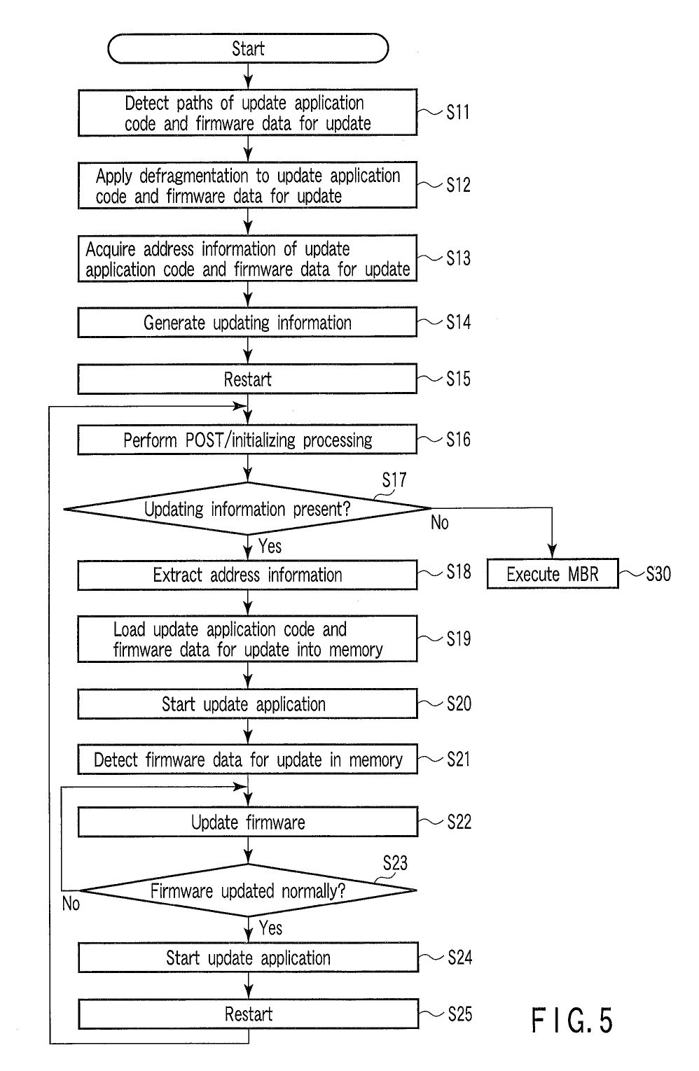

Next to this, a flow of processing in updating the firmware will be described with reference to a flowchart in FIG. 5.

The data detection module 301 of the setting application 300 detects paths for the firmware update application code 600A and the firmware data for update 700A (Step S11), The detection module 301 displays the file dialog box, and detects the path for the application code 600A by making the user specify the place and the file name of the application code 600A. The detection module 301 then displays the file dialog box, and detects the path of the application code 600A by making the user specify the place and the file name of the firmware data 700A.

The detection module 301 applies defragmentation to the firmware update application code 600A and the firmware data for update 700B (Step S12). The file defragmentation module 302 issues the command in order to apply defragmentation to the file toward the operating system 400 so as to maintain the data continuity of the firmware update application code 600A in the continuous and free areas in the HDD 121. The operating system 400 applies defragmentation to the application code 600A.

The defragmentation module 302 issues the command for applying the defragmentation to the operating system 400 so that the data continuity of the firmware data for update 700A in the continuous and free areas in the HDD 121. The operating system 400 applies the defragmentation to the firmware data 700A.

The setting application 300 acquires the address information showing the storage places in the HDD 121 for each of the firmware update application code 600B and the firmware data for update 700B (Step S13).

The address information acquisition module 303 issues the command for acquiring the address information of the application code 600B to acquire the address information thereof from the operating system 400. The acquisition module 303 issues a command to acquire the address information of the firmware data for update 700B and acquires the address information from the operating system 400. The address information to be acquired by the acquisition module 303 shows the LBA of the head sector in the storage area and the size (usually, integer multiple of 512 bytes) of the storage area.

The updating information generation/writing module 304 generates the updating information 220 including an index to be a mark in retrieval, address information of the firmware update application code 600B, and address information of the firmware data for update 700B, and stores the updating information 220 in the unreserved area 121A of the HDD 121 (Step S14).

The restart instruction module 305 instructs the operating system 400 to restart itself and the restart is implemented (Step S15).

After restarting, the POST/initializing module 501 executes the POST to check whether the necessary devices operate normally or not. Simultaneously, the module 501 initializes these peripheral devices (Step S16).

The updating information search module 502 searches the data in the unreserved area 121A between the MBR 210 and the first partition 121B and distinguishes whether the updating information 220 is present or not on the basis of the index (Step S17).

If the updating information 220 is stored in the first partition 121A, etc., the updating information search module 502 has to search a broad area; it takes a long while to search the area and to perform boot processing. However, the updating information 220 is stored in the unreserved area 121A of which the area is limited. Therefore, the information processing apparatus may shorten the search time.

If it is determined that the updating information is present (Yes, in Step S17), the application/firmware loading module 503 extracts each address information of the application code 600B and the firmware data 700B from the updating information 220 (Step S18).

The loading module 503 loads the application code 600B and the firmware data 700B in the HDD 121 in the memory 113 on the basis of the extracted address information (Step S19). At first, the loading module 503 specifies the LBA and the size to load the application code 600B from the HDD 121 to the memory 113. Next, the loading module 503 specifies the LBA and the size to load the firmware data 700B from the HDD 121 to the memory 113.

If the system BIOS 500 cannot understand the file system being in use by the operating system 400 for loading the file onto the memory 113, the loading module 503 cannot read the program and the data. In this embodiment, securing the continuity of the files makes it possible for the loading module 503 of the system BIOS 500 to read the firmware update application code 600B and the firmware data for update 700B without being conscious of the file system.

The application starting module 504 starts the firmware update application 600 loaded in the memory 113 (Step S20).

The firmware detection module 601 of the firmware update application 600 detects the storage place of the firmware data for update 700 on the memory 113 (Step S21).

The firmware rewriting module 602 updates the firmware data 700B by rewriting the firmware data 202 stored in the nonvolatile memory 201 through the firmware data for update 700 (Step S22).

The firmware rewriting module 602 validates whether or not the firmware data 202 in the nonvolatile memory 201 is normally updated (Step S23). If the rewriting module 602 determines that the firmware data 202 is not updated normally (No, in Step S23), the rewriting module 602 uses the firmware data 700 again to rewrite the firmware data 202 in the memory 201.

If the rewiring module 602 determines that the firmware data is updated normally (Yes, in Step S23), the updating information deleting module 603 deletes the updating information 220 in the HDD 121 (Step S24). Deleting the updating information 220 in the HDD 121 prevents the system of the apparatus from being brought into an infinite loop of updating the firmware again and again after restarting implemented after the deletion.

After the deletion, the deleting module 603 instructs the system BIOS to restart the application 600 (Step S25). The flowchart returns to Step S16, and the POST/initializing module 501 executes the POST to check if the necessary devices operate normally. Simultaneously, the initializing module 603 initializes the peripheral devices (Step S16).

In Step S17, if it is determined that the updating information 220 is not present (No, in Step S17), The MBR execution module 505 searches the MBR 210 to execute the MBR 210 (Step S30).

The MBR execution module 505 checks the preset device list in sequence to search a bootable peripheral device. If such device has not been found, an error occurs and the MBR execution module 505 stops the boot processing. If a bootable device has been found, the MBR execution module 505 loads the MBR 210 in the boot sector to execute it (Step S30).

The bootstrap loader of the MBR 210 checks a partition table to search an active partition. If the active partition is found, the bootstrap loader of the MBR 210 loads the boot sector of the active partition to execute it.

According to such processing given above, an information processing apparatus not having any flexible disk may rewrite the firmware at the time of power-on, and may rewrite the firmware in safety and surely.

While the application/firmware loading module 503 loads the firmware data for update 700B onto the memory 113, the firmware update application 600 may load the firmware data 700B onto the memory 113, based on the updating information 220.

In the aforementioned embodiment, while the example which updates the firmware in the HDD 121 has been described, the present invention is also applicable to update the firmware of other devices.

Although the firmware update application code 600A and 600B and the firmware data for update 700A and 700B are present in separated files, they may be packaged in one file.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a memory;
a device including a nonvolatile memory with firmware stored therein and a controller configured to execute processing based on the firmware;
a storage device configured to store updating data to update the firmware stored in the nonvolatile memory and update application code; and
a processor configured to execute processing to pose a state of no-fragmentation of the update application code and the updating data; processing to acquire address information showing storage places of the update application code and the updating data; processing to write updating information including address information of the update application code and the updating data; processing to detect whether or not the updating information is written in the storage device at the time of power-on; processing to load the update application code in the storage device in the memory on the basis of the updating information when it is determined that the updating information is written; and processing to update the firmware stored in the nonvolatile memory by using the updating data on the basis of the update application code loaded in the memory before booting an operating system having a multitasking function.

2. The apparatus according to claim 1, wherein the processor executes processing to delete the updating information by the update application code after the update processing.

3. The apparatus according to claim 1, wherein the processor executes the detection processing and the load processing by system BIOS.

4. The apparatus according to claim 1, wherein the device is a hard disk drive.

5. The apparatus according to claim 1, wherein the storage device is a hard disk drive, and the address information showing the storage place is a logical block address and a size of a head sector of the storage device.

6. The apparatus according to claim 5, wherein the updating information is written in an area between the head sector and the first partition of the storage device.

7. A firmware updating method, comprising:
posing a state of no-fragmentation of the update application code and the updating data and the update application code stored in the storage device;
acquiring address information showing storage places of the update application code and the updating data;
writing updating information including address information of the update application code and the updating data;
detecting whether or not the updating information is written in an area between a head sector and a first partition the storage device at the time of power-on;
loading the update application code in the storage device in a memory on the basis of the updating information when it is determined that the updating information is written in the areas; and
updating the firmware stored in a nonvolatile memory of a device by using the updating data on the basis of the update application code loaded in the memory before booting an operating system having a multitasking function.

8. The method according to claim 7, further comprising:
deleting the updating information by the update application code after the updating.

9. The method according to claim 7, wherein the loading is executed by a system BIOS.

10. The method according to claim 7, wherein the device is a hard disk dive.

11. The method according to claim 7, wherein
the storage device is a hard disk drive; and
the address information showing the storage place shows a logical block address and a size of a head sector of the storage device.

12. The method according to claim 11, wherein the updating information is written in an area between the head sector and the first partition of the storage device.
